(19) United States
(12) Patent Application Publication
(10) Pub. No.: US 2007/0285642 A1
(43) Pub. Date: Dec. 13, 2007

(54) EXPOSURE APPARATUS AND DEVICE MANUFACTURING METHOD

(75) Inventors: Akihiro Muto, Utsunomiya-shi (JP); Mitsuru Inoue, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/760,928

(22) Filed: Jun. 11, 2007

(30) Foreign Application Priority Data
Jun. 12, 2006 (JP) 2006-162813

(51) Int. Cl. G03B 27/42

(52) U.S. Cl. 355/53; 355/30

(57) ABSTRACT

At least one exemplary embodiment is directed to an exposure apparatus configured to perform an exposure process by interposing a liquid along a path of exposure light between a projection optical system and a substrate surface of an exposure object. A top plate that is coated with a diamond thin film or a diamond like carbon film at least on a surface in contact with the liquid and irradiated with the exposure light is used as a top plate for matching the height of an area surrounding the substrate surface with the height of the substrate surface during the exposure process. Alternately, a surface of a final lens of the projection optical system that is in contact with liquid is coated with a diamond thin film or a diamond like carbon film.

### BACKGROUND OF THE INVENTION

1. Field of the Invention

The present invention relates to an exposure apparatus used in a process for manufacturing semiconductor, liquid crystal, and other devices.

2. Description of the Related Art

A manufacturing process for semiconductor devices or liquid crystal display devices includes a process of transferring a pattern formed on a mask to a photosensitive wafer. An exposure apparatus used in this process generally has a mask stage for supporting a mask and a wafer stage for supporting a wafer, the mask pattern being transferred to the wafer via a projection optical system while sequentially moving the mask stage and the wafer stage. In recent years there has been a demand for greater resolution for projection optical systems in exposure apparatuses described above in order to handle finer detail in devices. The resolution of the projection optical system increases as the exposure wavelength being used becomes shorter or as the numerical aperture of the projection optical system becomes larger. This is why the exposure wavelength used in exposure apparatuses has grown shorter and the numerical aperture of the projection optical system has grown year after year.

Like resolution, depth of focus is also important when performing exposure. Resolution R and depth of focus δ are expressed by the following formulas:

R=k₁·λ/NA (1)

δ=±k₂·λ/NA² (2)

where, λ is the exposure wavelength, NA is the numerical aperture of the projection optical system, and k₁ and k₂ are process coefficients.

From formula (1) and formula (2) is it clear that making the exposure wavelength λ shorter and the numerical aperture NA larger in order to improve the resolution (i.e. in order to decrease the resolution R) results in the depth of focus δ becoming narrower. If the depth of focus δ becomes too narrow, it becomes difficult to match the wafer surface to the image plane of the projection optical system, and there is a risk of insufficient focus margin during exposure. Accordingly, a liquid immersion exposure has been proposed (International Publication WO99/49504) as a method for substantially shortening the exposure wavelength and widening the depth of focus. With such a liquid immersion exposure, a liquid immersion area is formed by filling the space between a bottom surface of the projection optical system and the wafer surface with water or an organic solvent, etc. This method further improves resolution and increases the depth of focus approximately n times by taking advantage of the fact that the wavelength of the exposure light in the liquid becomes 1/n of that in the air (n being the refractive index of the liquid, ordinarily between 1.2 and 1.6, approximately).

However, irradiating, with the exposure light, the liquid, filling the space between the projection optical system and the wafer, activates the liquid, in turn causing oxidation of the liquid contact surface and the surface, which is irradiated with the exposure light. If water remains on the liquid contact surface, vaporization heat is generated if any water left behind on the liquid contact surface is irradiated with the exposure light. This vaporization heat causes a problem of thermal deformation on the liquid contact surface, adversely affecting the exposure accuracy.

### SUMMARY OF THE INVENTION

At least one exemplary embodiment of the present invention is directed to an exposure apparatus configured to at least one surface of a top plate, wherein the top plate is configured to match the height of an area surrounding a substrate surface with the height of the substrate surface that is in contact with a liquid, wherein the surface of the top plate is coated with a hard thin film, wherein the liquid is disposed along a path of an exposure light between a projection optical system and the substrate surface, and wherein the hard thin film is one of a diamond thin film and a carbon film having at least some diamond like properties. Additionally, another exemplary embodiment of the present invention is directed to a device that is manufactured using the above exposure apparatus.

Further features of the present invention will become apparent from the following description of exemplary embodiments with reference to the attached drawings.

### BRIEF DESCRIPTION OF THE DRAWINGS

FIG. 1 is a lateral view showing a general constitution of an exposure apparatus according to an exemplary embodiment.

FIG. 2 is a view showing the constitution of a first exemplary embodiment, with the liquid immersion area portion of the exposure apparatus shown in FIG. 1 magnified.

FIG. 3 is a cross-sectional view showing a member for the exposure apparatus according to the first exemplary embodiment.

FIG. 4 is a view showing the constitution of a second exemplary embodiment, with the liquid immersion area portion of the exposure apparatus shown in FIG. 1 magnified.

FIG. 5 is a view showing a device manufacturing method applied to the exposure apparatus according to the first or second exemplary embodiment.

FIG. 6 is a view showing a wafer process in the device manufacturing method shown in FIG. 5.

### DESCRIPTION OF THE EMBODIMENTS

The following description of at least one exemplary embodiment is merely illustrative in nature and is in no way intended to limit the invention, its application, or uses.

Processes, techniques, apparatus, and materials as known by one of ordinary skill in the relevant art may not be discussed in detail but are intended to be part of the enabling description where appropriate, for example the plasma etching of semiconductors and the materials used.

In all of the examples illustrated and discussed herein any specific values or materials, for example cyanate resin, should be interpreted to be illustrative only and non limiting. Thus, other examples of the exemplary embodiments could have different materials.

Notice that similar reference numerals and letters refer to similar items in the following figures, and thus once an item is defined in one figure, it may not be discussed for following figures.

Note that herein when referring to correcting or corrections of an error (e.g., an aberration), a reduction of the error and/or a correction of the error is intended.

### First Exemplary Embodiment

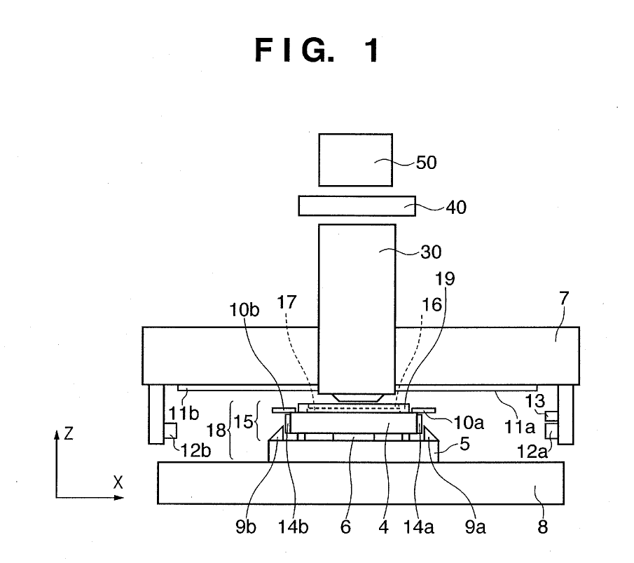

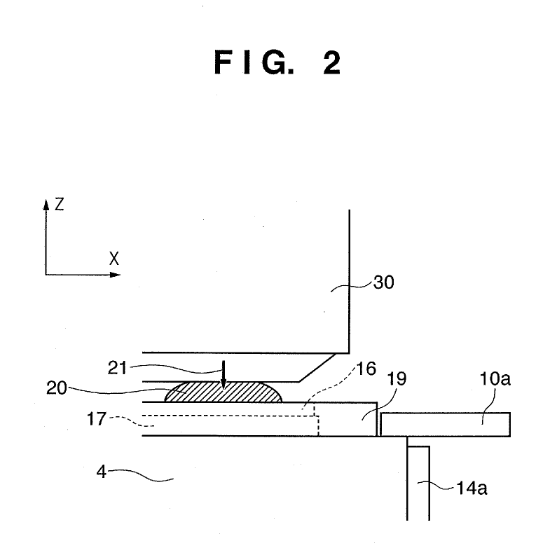

An exposure apparatus according to a first exemplary embodiment is described, with reference to FIGS. 1 and 2. FIG. 1 is a lateral view showing an example of an exposure apparatus according to the first exemplary embodiment. This exposure apparatus can form a fine pattern (e.g., from a reticle) on a substrate, and can be used in the manufacture of devices on which fine patterns are formed such as semiconductor integrated circuits and other semiconductor devices, micro-machines, and thin film magnetic heads.

In the exposure apparatus, a wafer 16, which is a substrate, is irradiated with exposure light as exposure energy from an illumination system 50 via a reticle 40, which is an original plate, and a projection lens as a projection optical system 30. Moreover, in this description, “exposure light” is a general term including but not limited to visible light, ultraviolet light, EUV light, X rays, electron beams, and charged particle beams. Further, “projection lens” is a general term including but not limited to refractive lenses, reflective lenses, catadioptric lens systems, charged particle lenses. A desired pattern is formed on a wafer placed on an alignment apparatus by irradiating it with exposure light via the projection lens. As a method for transferring a pattern, step and repeat methods and step and scan methods are well known, and either may be adopted in the present exemplary embodiment.

In FIG. 1, an alignment apparatus 18 is constituted by a coarse moving stage 5 which moves over a wide range with respect to a base 8, and a fine moving stage 15 provided to the coarse moving stage 5 which moves over a small range with respect to the coarse moving stage 5. On the fine moving stage 15, a wafer 16 is held by a fine moving stage top plate 4 via a wafer chuck 17, and is aligned with high accuracy with respect to the pattern. Further, the fine moving stage 15 is provided with a top plate 19 disposed around the wafer chuck 17 and having a top surface portion with a height matching the top surface of the wafer 16 held by the wafer chuck 17. With an exposure apparatus which performs exposure via a liquid between a final projection lens of the projection optical system 30 and an exposure surface of the wafer 16, the wafer 16 can be surrounded by a surface of the same height as the wafer 16 in order to ensure a liquid immersion area which is stable also at the edges of the wafer 16. This is why the top plate 19 is provided.

The coarse moving stage 5 is movably supported in the X and Y directions with respect to the base 8. The coarse moving stage 5 can float off the base 8 and can be supported in a non-contact fashion, from the perspective of accuracy. As a supporting mechanism for such a coarse moving stage 5, constitutions are given such as floating a stage using air bearings and floating a stage using magnetic force, such as magnetic attraction force or Lorentz force. Further, as a driving mechanism for the coarse moving stage 5, a plane motor can be used in the present exemplary embodiment. Plane motors generally create a driving force by flowing a current through a coil by providing a movable element (the coarse moving stage 5) or a stator (the base 8) with coils, and the method may be a variable magnetic resistance method (plane pulse motor) or a Lorentz force method. Moreover, these mechanisms are not discussed in detail as they are discussed in Japanese Patent Laid-Open Nos. 11-190786 and 2004-254489.

The fine moving stage 15 can be linked to the coarse moving stage 5 by, for example, electromagnetic coupling, and can move in a large stroke in the X and Y directions according to the movement of the coarse moving stage 5. The fine moving stage 15 can include an actuator 6 between the fine moving stage 15 and the coarse moving stage 5. The actuator 6 can cause the fine moving stage top plate 4 to move with respect to the coarse moving stage 5 over a small range. A linear motor, an electromagnet, an air actuator, a piezo element, or other equivalent device as known by one of ordinary skill in the relevant arts can be used as the actuator 6. In at least one exemplary embodiment the movable element and the stator do not come into contact, thus improving accuracy.

In at least one exemplary embodiment the drive axes of the fine moving stage 15 can be a six-axis drive, where the six axes are in the X direction, the Y direction, the Z (vertical) direction, the ωx direction (a rotating direction around the X axis), the ωy direction (a rotating direction around the Y axis), and the ωz direction (a rotating direction around the Z axis), although the number and label of axis are not limited to those stated herein.

A supporting member 7 is a structure for supporting the projection optical system 30. In the present exemplary embodiment, the supporting member 7 is a reference structure acting as a reference for measuring the position of the fine moving stage 15. The supporting member 7 is provided with an X interferometer 13 for measuring the X position of the fine moving stage 15, a Y interferometer (not shown) for measuring the Y position, and a Z interferometer 12a and 12b for measuring the Z position.

The coarse moving stage 5 is provided with mirrors 9a and 9b in which the angle formed by the reflective surfaces and the Z direction is an acute angle (45° in this case). The fine moving stage top plate 4 is provided with mirrors 10a and 10b in which the reflective surfaces are perpendicular to the vertical direction and the reflective surfaces match with the top surface of the fine moving stage top plate 4. Plane bar mirrors 14a and 14b are disposed to the side surfaces of the fine moving stage top plate 4, which are separate from the mirrors 10a and 10b. The supporting member 7 is provided with mirrors 11a and 11b in which the reflective surfaces are perpendicular to the vertical direction. An accurate position of the fine moving stage top plate 4 can be measured using the combination of these mirrors and the interferometers.

In the above description, the coarse moving stage 5 can be driven by the plane motor, but this is not a limitation, many driving mechanisms are possible. For example, the coarse moving stage 5 can be driven by a linear motor using a guide.

FIG. 2 is a magnified view of a portion of FIG. 1. In the exposure apparatus of the present exemplary embodiment, to facilitate exposure by the liquid immersion, the top plate 19 is provided disposed around the wafer chuck 17 and having a top surface portion with the same height as the top surface of the wafer 16 held by the wafer chuck 17. As described above, the top plate 19 is disposed so as to surround the wafer 16, and therefore the top surface portion of the top plate 19 is exposed to a liquid immersion fluid 20. Furthermore, when exposure is performed in units of one shot including a plurality of chip patterns, part of the area of the one shot also falls on the top plate 19 when an effort is made to use the entire usable surface of the wafer. In this case, the top plate 19 is irradiated with the exposure light. As a result, the top plate 19 comes in contact with the liquid immersion fluid 20, which can be activated by the exposure light, and becomes more easily oxidized. Accordingly, in the first exemplary embodiment, a member coated with a diamond thin film, described below, is used for at least those portions of the surface of the top plate 19 that come in contact with the liquid immersion fluid and are irradiated with the exposure light.

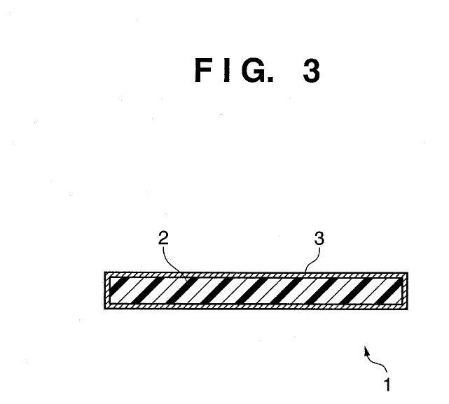

FIG. 3 is a cross-sectional view showing an example of a material in the present exemplary embodiment usable as the top plate 19. An exposure apparatus member 1 in FIG. 3 is formed by coating a surface of a fiber-reinforced plastic (FRP) 2 with a diamond thin film 3 using a microwave plasma CVD method. Note that for such coating a diamond like carbon (DLC) film may be used in place of the diamond thin film 3, and in this case, too, coating can be done using a microwave plasma CVD method. While the DLC film has an amorphous structure, it also has diamond bonds in places, and has a hardness near that of diamond. Carbon fiber is a non-limiting example of a material that can be used as a fiber for the reinforcement material in the fiber-reinforced plastic, but this is not a limitation, and glass fiber and aramid fiber will also do. At least one exemplary embodiment uses a cyanate resin with outstanding shape stability and outstanding low outgas for a matrix, but this is not a limit, and an epoxy resin will also do.

With the material shown in FIG. 3, by coating the fiber-reinforced plastic (FRP) surface with a diamond thin film (including DLC film), the following effects can be achieved:

oxidation of surfaces which are liquid contact surfaces and which are irradiated with the exposure light is prevented and/or reduced;

thermal deformation due to vaporization heat is reduced due to less water remaining on the liquid contact surface, making it possible to improve exposure accuracy; and

rigidity is improved, suppressing scratching and deformation.

In the first exemplary embodiment, the top plate 19 can be formed using the member described above with the structure shown in FIG. 3. In other words, with the first exemplary embodiment, the top plate 19 is used which is made of fiber-reinforced plastic (FRP) whose surface is coated with a diamond thin film (including DLC film). Therefore, oxidation of the surface of the top plate 19, which is irradiated with the exposure light is prevented and/or reduced. Moreover, since there is less water left behind on the surface of the top plate 19, thermal deformation due to vaporization heat is reduced, and exposure accuracy can be improved. Further, rigidity is improved and scratching and deformation are suppressed, by coating with a diamond thin film or a DLC film, thereby making it possible to provide a highly accurate exposure apparatus. Since the top plate 19 in the exposure apparatus of the first exemplary embodiment is made of a fiber-reinforced plastic (FRP), and in particular uses a fiber-reinforced plastic with carbon fiber as a reinforcing material, a light-weight top plate 19 can be provided. In other words, the exposure apparatus can be made lighter with the first exemplary embodiment.

Moreover, FIG. 3 shows that the diamond thin film 3 is coated over the entire surface of the fiber-reinforced plastic 2, but when applying this to the top plate 19, the diamond thin film 3 may only coat at least those portions which come in contact with the liquid immersion fluid and are irradiated with the exposure light. In other words, at least those portions of the surface of the top plate 19, which are exposed to the liquid immersion fluid 20 and exposure light 21 may be coated with the diamond thin film (including the DLC film).

### Second Exemplary Embodiment

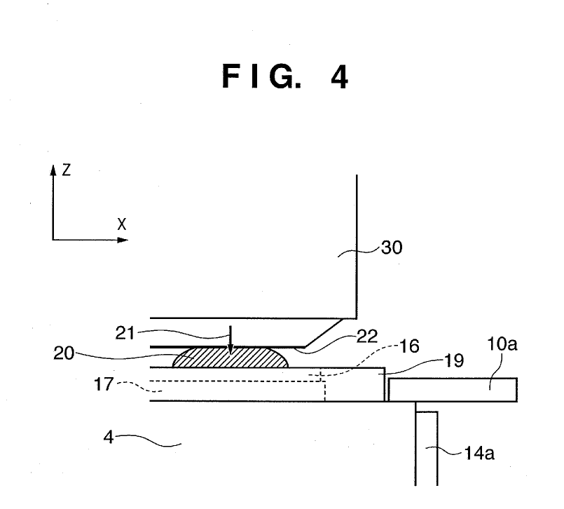

An exposure apparatus according to a second exemplary embodiment is described, with reference to FIG. 4. Note that the overall constitution of the exposure apparatus of the second exemplary embodiment is the same as the first exemplary embodiment (FIG. 1).

The projection lens of the projection optical system 30 of an exposure apparatus according to the second exemplary embodiment is described using FIG. 4. FIG. 4 is a magnified view of the liquid immersion area portion of FIG. 1. As shown in FIG. 4, in the second exemplary embodiment, a wetted surface 22 of a last projection lens in the projection optical system 30 (the lens closest to the wafer) is coated with a diamond thin film. Needless to say, the entirety of the last projection lens can be coated with a diamond thin film. Furthermore, a DLC thin film coating may be used, as in the first exemplary embodiment.

With this second exemplary embodiment, coating the wetted surface of the last projection lens with a diamond thin film (or a DLC film) reduces the water left behind on the last lens wetted surface of the projection lens, which is a liquid contact surface. For this reason, there is less thermal deformation due to vaporization heat and the exposure accuracy can be improved. For the same reason as in the first exemplary embodiment, oxidation of the lens wetted surface due to the liquid immersion fluid 20 activated by the exposure light is also prevented and/or reduced. In other words, the projection lens provided with both water repellency and acid resistance can be used in the exposure apparatus as the last lens, making it possible to provide a highly accurate exposure apparatus.

In addition to the above-mentioned effects, by coating with a diamond thin film, it is possible to provide a highly accurate exposure apparatus with improved projection lens rigidity and suppressed scratching and deformation of the lens surface.

Moreover, it goes without saying that the top plate 19 described in the first exemplary embodiment can also be used together with the last projection lens of the second exemplary embodiment.

As described above, with the above exemplary embodiments, surfaces, which are liquid contact surfaces and which are irradiated with the exposure light can be coated with a diamond thin film (including DLC film). For this reason, oxidation of the liquid contact surfaces is prevented (and/or reduced) and scratching and deformation are suppressed due to improved rigidity, thereby making it possible to provide a highly accurate exposure apparatus. Moreover, surfaces which are liquid contact surfaces and which are irradiated with the exposure light have improved water repellency and deformation due to vaporization heat is prevented and/or reduced, thereby making it possible to realize highly accurate exposure.

<Manufacturing Method for a Device Using the Exposure Apparatus>

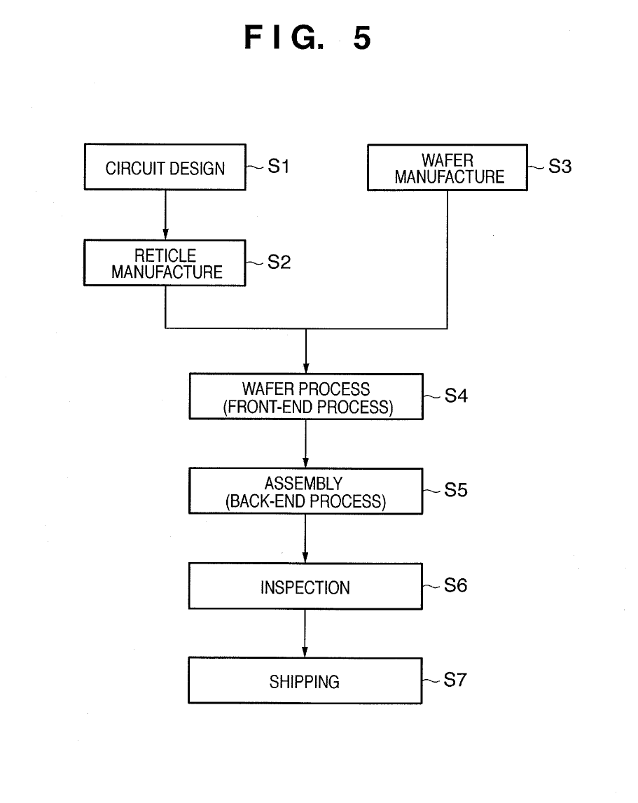

Next, a manufacturing process for a semiconductor device using the exposure apparatus is described. FIG. 5 is a view showing a flow of an overall manufacturing process for a semiconductor device. In step S1 (circuit design), the circuits of the semiconductor device are designed. In step S2 (reticle manufacture), the reticle is made based on the designed circuit patterns.

In step S3 (wafer manufacture), a wafer is manufactured using a material such as silicon. Step S4 (wafer process) is called a front-end process, and uses the reticle and wafer to form the actual circuits on the wafer using lithography technology with the exposure apparatus. Next, step S5 (assembly) is called a back-end process, and is a process for creating the semiconductor chips from the wafer manufactured in step S5, and includes assembly processes such as an assembly process (dicing, bonding) and packaging process (chip sealing). In step S6 (inspection), inspection of the semiconductor device manufactured in step S5 is performed, including operation verification testing and endurance testing. The semiconductor device is completed after passing through such processes, and in step S7 is shipped.

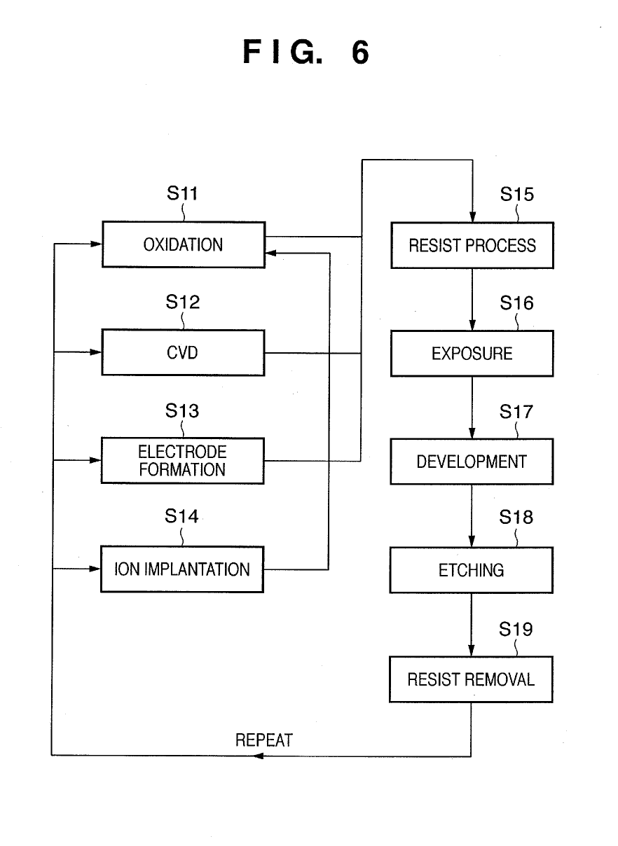

FIG. 6 is a view showing a flow of the wafer process in step 4. The wafer process of step 4 is described below.

First the surface of the wafer is oxidized (oxidation step S11) and an insulation film is formed on the wafer surface (CVD step S12). Electrodes are formed on the wafer through vapor deposition (electrode forming step S13) and ions are implanted in the wafer (ion implantation step S14). Then, a photosensitive agent is applied to the wafer (resist process step S15), and a circuit pattern is transferred to the wafer after the resist process step by the exposure apparatus of the first or second exemplary embodiment (exposure step S16). Further, the wafer exposed in the exposure step is developed (developing step S17), portions other than the resist image developed in the developing step are etched off (etching step S18), and resist unneeded after the etching is removed (resist removal step S19). By repeating these steps, multiple circuit patterns can be formed on the wafer.

Thus, an inexpensive and detailed device can be provided by manufacturing a device using the exposure apparatus described in the first exemplary embodiment or the second exemplary embodiment.

As described above, with exemplary embodiments of the present invention, adverse effects on exposure accuracy which can arise on the liquid contact surface in the process using a liquid immersion exposure are reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-162813, filed Jun. 12, 2006, which is hereby incorporated by reference herein in its entirety.

What is claimed is:

1. An exposure apparatus comprising:
at least one surface of a top plate, wherein the top plate is configured to match the height of an area surrounding a substrate surface with the height of the substrate surface that is in contact with a liquid, wherein the surface of the top plate is coated with a hard thin film, wherein the liquid is disposed along a path of an exposure light between a projection optical system and the substrate surface, and wherein the hard thin film is one of a diamond thin film and a carbon film having at least some diamond like properties.

2. The apparatus according to claim 1, wherein
a surface of a final lens of the projection optical system that is in contact with the liquid is coated with a hard thin film, wherein the hard thin film is one of a diamond thin film and a carbon film having at least some diamond like properties.

3. The apparatus according to claim 1, wherein
the top plate is formed from fiber-reinforced plastic.

4. The apparatus according to claim 3, wherein
the top plate is formed from a fiber-reinforced plastic using carbon fiber as a reinforcement material.

5. The apparatus according to claim 1, wherein
the diamond thin film or the carbon film is coated using a microwave plasma CVD method.

6. A device manufacturing method comprising:
a device that is at least partially manufactured using the exposure apparatus according to claim 1, wherein the exposure apparatus is used to form a reticle image on the substrate surface, which is used to develop photoresist on the substrate surface, where the substrate is etched using the developed photoresist, and the etched substrate is used in the device.
